(19) United States
(12) Patent Application Publication
(10) Pub. No.: US 2026/0298161 A1
(43) Pub. Date: Oct. 1, 2026

(54) SYSTEMS AND METHODS FOR SYSTEM DRIVEN INERTIA DETERMINATION

(71) Applicant: Caterpillar Inc., Peoria, IL (US)

(72) Inventors: Travis Eugene Barnes, Metamora, IL (US); Christopher F. Gallmeyer, Chillicothe, IL (US)

(21) Appl. No.: 19/092,666

(22) Filed: Mar. 27, 2025

(51) Int. Cl. F02D 29/06; F02D 28/00

(52) U.S. Cl. CPC F02D 29/06; F02D 28/00

(57) ABSTRACT

A system and method for controller gain determination based on inertia of a driven system is described herein. The system and method include a computing device for perturbing an engine speed and recording engine operating parameters such as speed in response to the perturbation. The engine may be decoupled from load components of the system to evaluate against a known inertia of the engine. The engine may be coupled subsequently to the load system and the speed response recorded and the relative rate of response between the two instances of perturbation used to determine the relative inertia and corresponding gain for the controller of the system to remain stable.

### TECHNICAL FIELD

The present application relates generally to internal combustion engines governor adjustment and, more particularly, to determining an inertia of a system driven by an internal combustion engine for determining an adjustment to governor gain.

### BACKGROUND

Internal combustion engines are used for various mobile applications, and also for stationary applications such as generator sets, engine-driven compressors, engine driven pumps, and others. While some applications might require a near constant load on the engine, the loading on an engine operating in a generator set may vary relatively quickly over time, especially when the electrical load on the generator varies.

In standby electric power applications, the standby generator set provides power quickly in response to an emergency, or to supplement electrical power provided by another power source such as a renewable power source. Diesel-fueled engines may increase fuel rapidly without waiting for a turbocharger to spin up to increase airflow. When larger turbochargers are used, the rotational inertial of the turbocharger impacts how fast the turbocharger can spin up and thus impact air flow to an engine.

Internal combustion engines used for generating power, such as generator sets, are needed to maintain a pre-determined speed to maintain the output power specifications. If the engine speed is not correct then the generator will not maintain the required output. Accordingly, a governor for a generator set may be used to control the engine speed, and in some applications, the generator load. To select the correct settings (e.g., gain) for the governor, the capabilities and characteristics of the system such as the inertia of the system driven by the internal combustion are needed. Engine speed governors are significantly impacted by the driven inertia of the system. Incorrect or inaccurate estimation or input of the driven inertia of the system results in incorrect speed control and response to inputs and changes during step load increases that causes incorrect output specifications from the generator set.

Existing systems may provide for self-tuning systems of determining gain for servos or other such equipment. One such system is described in U.S. Pat. Publication No. 2023236572 to Lu (hereinafter “the '572 publication”). The '572 publication provides for a self-tuning method for control gain of a servo actuator. The '572 publication describes receiving current feedback information from a motor to determine an estimated torque value and an estimated acceleration value for the motor. Based on the torque and acceleration estimates, the system estimates a system inertia for the driven system and determines an estimated gain for the servo actuator based on the estimated system inertia.

Although the '572 publication describes a system for self-tuning and estimating control gain for a servo, the '572 publication does not address how to estimate the total inertia of a system without the current feedback signal or to accurately determine the inertia response of the system attached to the internal combustion engine for accurately setting the gain of the governor before operation in service.

Examples of the present disclosure are directed toward overcoming the deficiencies described above.

### SUMMARY OF THE INVENTION

In some examples, the systems and techniques described herein may provide a method for determining inertia of a driven system for governor gain adjustment.

In some aspects, the techniques described herein relate to a method including determining a first gain for a controller of a first system including an internal combustion engine, the first gain associated with a first inertia of the first system, introducing a first perturbation to change an engine speed of the internal combustion engine, and determining a first rate of change of the first system in response to the first perturbation. The internal combustion engine is then installed in a field installation by coupling at least the internal combustion engine of the first system to a second system. The method includes introducing a second perturbation to change the engine speed, the second perturbation equal to the first perturbation, determining a second rate of change of the second system in response to the second perturbation, determining a second gain for the controller based at least in part on a ratio of the first rate of change to the second rate of change, and controlling operation of the system based on the second gain.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a block diagram of a controlled power-driven system and method for determining a system gain for a controller of the power-driven system, according to at least one example.

FIG. 2 illustrates a block diagram of an example system for determining and setting a gain setting for control of an engine, according to at least one example.

FIG. 3 illustrates an example representation of inputs and data used for determining factors such as torque and acceleration to determine the inertia of a system connected to an engine for determining a controller gain setting, according to at least one example.

FIG. 4 illustrates an example diagram of a desired speed control and response of a system based on a first and a second inertia for determining a controller gain setting, according to at least one example.

FIG. 5 illustrates an example diagram of a step fuel input perturbation to an engine and a response of a system based on a first inertia and a second inertia for determining a controller gain setting, according to at least one example.

FIG. 6 illustrates a method for determining a controller gain setting for an engine and driven system, according to at least one example.

FIG. 7 illustrates a controller for use with the systems and methods described herein, according to at least one example.

### DETAILED DESCRIPTION

Wherever possible, the same reference numbers will be used throughout the drawings to refer to the same or like parts. In the figures, the left-most digit(s) of a reference number identifies the figure in which the reference number first appears.

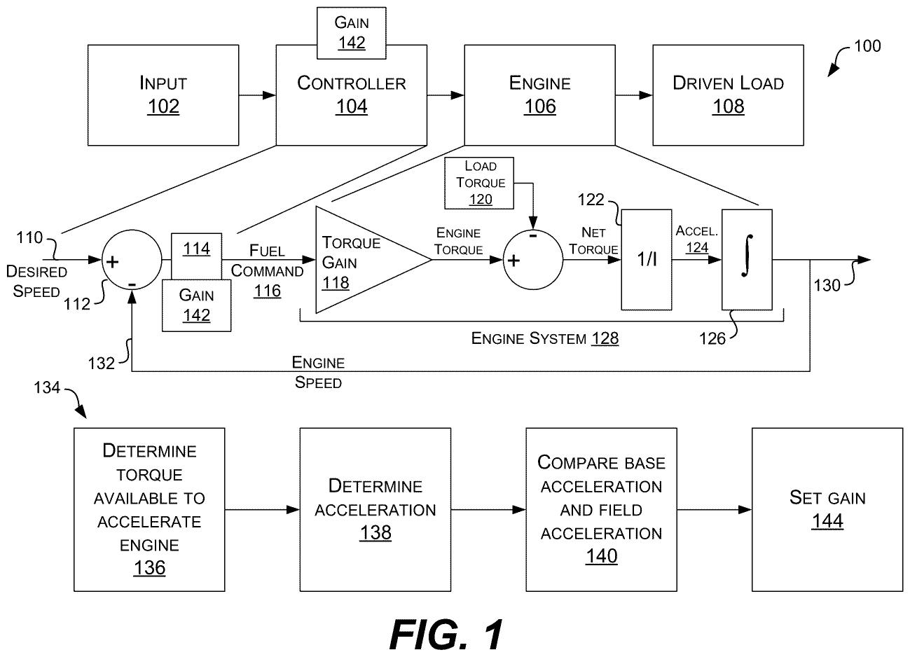

FIG. 1 illustrates a block diagram of a controlled power-driven system and method for determining a system gain for a controller of the power-driven system, according to at least one example. The system 100 includes an input 102, controller 104 having a gain 142, engine 106, and driven load 108. The input 102 may include a speed input such as a desired speed 110, or may include a fuel input, signal input, or other input used by the controller 104 to control operation (e.g., speed) of the engine 106. The input 102 may, in an example, include a speed setpoint and the controller may then adjust fuel input to get the actual speed to match the speed setpoint. The input 102, for a diesel engine may include diesel fuel input into the system and/or other inputs in other examples.

The controller 104 and/or controller 114 is based on an error from a sum component 112 with the gain 142 and engine speed feedback (e.g., feedback 132) to generate a fuel command 116 to control the engine 106. The fuel command 116 is provided to the engine system 128 and the fuel is consumed to generate engine torque and drive the engine system 128. The engine 106 is modeled in FIG. 1 by the engine system 128 to determine the inertia to adjust the gain 142 for the controller 104 (e.g., controller 114). In the engine system 128 model, the fuel command 116 is received and the engine system 128 uses a torque gain 118 to determine an engine torque value. The torque gain 118 is a result of hardware that receives the fuel command 116 and converts the fuel to torque as the engine torque. The hardware includes the fuel system that takes the fuel command and delivers the fuel to an engine cylinder. The delivered fuel is burned in the engine cylinder and the energy extracted and converted to engine torque using the hardware of the pistons and crankshaft. The torque gain 118 represents all of the hardware and components into a single component to identify the amount of engine torque that a particular quantity of fuel will produce. The model of the engine system 128 uses the engine torque value as well as the load torque 120 value for the driven load 108 to determine a net torque. Additional frictional torque exists in the system, and it may be either estimated and assumed to be fixed between a baseline test and for a configuration test in the field so the impact of the frictional torque is the same for both tests. The net torque includes the engine torque and the load torque 120 (which may include the friction torque), however during setup and configuration of the gain 142 for the controller 104 (e.g., controller 114), the load torque is zero. The inertia 122 (represented as 1/I) includes the engine inertia as well as the driven inertia. By monitoring the acceleration 124 of engine speed and the engine speed 130, the inertia of the engine 106 and the driven load 108 may be determined. The inertia 122 and the integrator 126 provide a mathematical representation of the engine response to the torque.

The controller 104 (also shown as controller 114 with gain 142 in FIG. 1) implements the gain 142 which corresponds to a factor in the controller 104 by which the controller 104 implements signals at the engine 106. In an example, the gain 142 is the magnitude of change in the fuel (also the magnitude in the change of torque) due to speed error based on the feedback 132. The gain 142 may include a parameter associated with a relationship between an error signal and the output of the controller 104 such as the feedback 132 or other error signal. The gain 142 is impacted by the inertia of the engine and the driven load and the optimal value for the gain 142 is dependent on the system inertia. The gain 142 may include a parameter that is set by an operator or engineer during setup or configuration of the system 100.

The controller 104 may be a single controller or may include more than one controller disposed to control various functions and/or features of the system. For example, a master controller, used to control the overall operation and function of the generator set may be cooperatively implemented with an engine controller used to control the engine 106. In this embodiment, the term “controller” is meant to include one, two, or more controllers that may be associated with the engine 106 and that may cooperate in controlling various functions and operations of the engine 106 and driven load 108.

The controller 104 may be a standalone controller or part of a larger control scheme for controlling and monitoring the operation of the system 100 including the engine 106 and the driven load 108. The controller 104 may be further integrated with and be operating within another control element of an overall environment.

FIG. 1 further includes a flow diagram for a process 134 to set a controller gain so that an in-field system gain matches a system reference gain, for example when configuring the system 100 for use when the engine 106 arrives in the field and is connected to the driven load 108. Because the inertia of the system changes from a factory configuration versus an in-field installation, the inertia of the engine and driven load 108 may change, and may continue to change after installation. Accordingly, the goal of the process 134 is to adjust the gain associated with the controller 104 to compensate for system gain changes introduced by an inertia change of the system so the resulting gain remains the same as the reference gain. The process 134 may be implemented through a computing device to determine the gain 142 based on the acceleration response of the engine 106 to a change in the input (e.g., a step input). In examples, the inertia of the driven load 108 may not need to be explicitly calculated, but rather based on the relative response of the engine 106 to the step input in a first configuration (e.g., factory setting) and in a second configuration (e.g., in the field) the gain 142 may be adjusted for performance of the engine 106 operating in the field to drive the driven load 108.

The process 134 includes determining torque available to accelerate the engine at step 136. The torque available may be a known value, such as a predefined output torque of the engine 106 at a particular engine speed. In examples, the torque available to accelerate the engine may be determined for two different conditions, a base acceleration and the field acceleration. When the engine 106 is initially configured (e.g., when a diesel engine is configured for operation at a factory) the torque available for acceleration may be the torque of the engine 106, as the engine may be configured without a load connected. The acceleration response of the engine 106 may be used to determine the relation between a base inertia and a new inertia for the system 100 and thereby set the gain 142. As shown in equation (1) below, the torque (τ) is equal to the inertia (I) multiplied by the acceleration (α) for the system 100.

$$τ = I α \qquad Equation ( 1 )$$

The acceleration for the engine 106 is therefore equal to the torque divided by the inertia, as shown in equation (2).

$$α = \frac{τ}{I} \qquad Equation ( 2 )$$

With a known torque value for accelerating the engine 106 (e.g., by controlling the input to the engine 106), the change in acceleration between the base configuration and the new configuration is entirely reflected in the relative change in inertia of the driven load 108. Accordingly, the controller gain may be reconfigured to maintain the targeted system gain.

At step 138, the acceleration for the engine 106 is determined in response to a step input to the engine in both a base test and a field test to determine the base acceleration and the field acceleration of the engine 106.

The base acceleration may be determined at a factory or during engine development at a lab and/or as part of a configuration with a first gain value, such as a known value associated with the engine 106 may be provided. The first gain is associated with a first inertia of a system and is a known value, such as may be determined at a factory setting or environment. A first acceleration response associated with the first gain may be recorded when the system is configured during development and/or factory testing such as with a driven load having a known inertia.

The driven load 108 may be coupled to the engine 106 when it arrives in the field. With the driven load 108 connected to the engine 106, the system 100 may undergo a second perturbation to the engine speed, in response to a fuel input and/or a controller engine speed step function. In response to the second perturbation, with the driven load 108, the rate of acceleration of the engine 106 may be recorded. The rate of acceleration may be recorded as the engine speed increases and decreases in response to the step function input. The first acceleration and the second acceleration may then be used to determine a relationship between the first base inertia and the second field inertia for setting the controller gains in the controller 104 to achieve the same gain.

In examples, the energy or torque available to accelerate the engine 106 may not be exactly known due to losses within the engine 106 and/or system 100. The energy output of the engine 106 being repeatable, even if unknown, enables determination of the relative change in inertia between when the driven load 108 is disconnected and subsequently connected. The ratio of the rate of change with two different inertia terms (connected to driven load 108 and running as a bare engine, e.g., a factory or development determined value that may be saved in the controller 104) may be used to determine the gain 142. By using the same torque value for a reference inertia acceleration case (just the engine 106) and the unknown inertia case (for the system 100), the unknown inertia may be determined and/or the relationship between the reference inertia and the unknown inertia may be determined based on the ratio of the acceleration response in each circumstance at step 140 by comparing the base acceleration and the field acceleration.

In examples, if the torque output of the engine 106 is known then the inertia for the driven load 108 and the engine inertia for the total system inertia could be determined based on the acceleration rate in response to the input value without the reference inertia value.

In response to the perturbations and the resultant change in the engine speed (e.g., acceleration), the inertia of the system 100 may be estimated and/or determined and/or used to determine a controller gain to maintain the system gain as a constant. In examples, the inertia may not be determined, but rather the relative inertia of the first configuration (e.g., factory setting) and the inertia in the field may be compared to determine the controller gain. In examples, the inertia of the system 100 may be estimated for determination of the controller gain for optimization without requiring detailed knowledge or analysis of the inertia or impact of various components coupled to the system 100 such as the driven load 108. As the engine speed is impacted by the driven inertia of the system 100, adjustment of the gain 142 with a change in inertia is conventional, however the estimation or determination of inertia of the system 100 may be difficult to determine. The gain 142 and the inertia are related by equation (3) below.

$$\frac{{K\_loop}_{new}}{{K\_loop}_{base}} = \frac{{Inertia}_{new}}{{Inertia}_{base}} \qquad Equation ( 3 )$$

As illustrated by the equation (3), gain 142 (K_loop) may be set at step 144 by comparing the first rate of change of the engine speed with the second rate of change of the engine speed (e.g., with a known or equal torque value the relationship between the base inertia and the new inertia will be entirely determined by the relationship between the base acceleration and the new acceleration). As the first inertia (inertia_{base}) associated with the first portion of the system 100 may be a known quantity, the relation between the original and new inertia (inertia_{new}) may be determined based on the acceleration response of the engine to the same torque. Accordingly, the ration of the inertia may instead be represented by the acceleration of the new setting over the base acceleration. Accordingly, the technician or system user may determine the controller gain for the controller 104 without requiring sophisticated sensors or instrumentation, and instead relying on the step input and acceleration response of the engine.

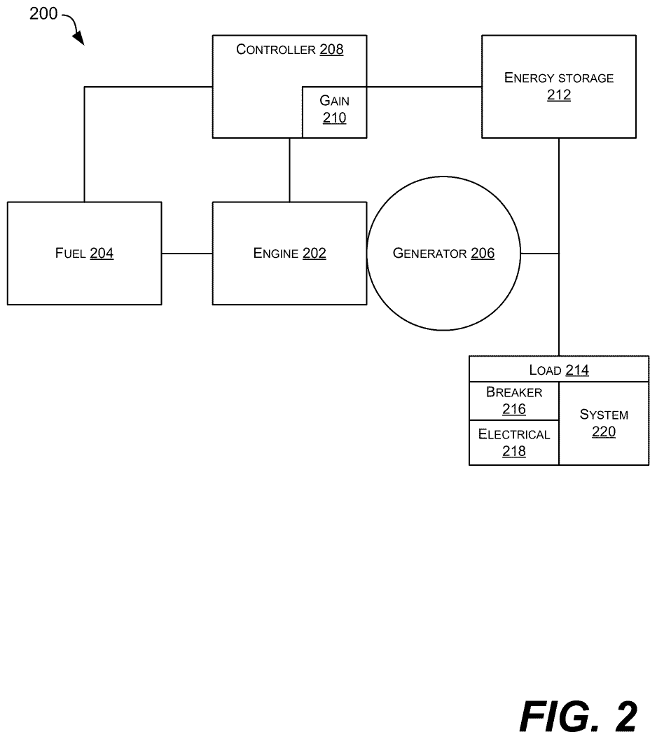

FIG. 2 illustrates a block diagram of a system 200 for determining and setting a gain setting for control of an engine, according to at least one example. The system 200 may include a generator set such as an engine-driven generator, commonly referred to as a genset or a genset power system, is the combination of an engine 202 (such as a diesel-powered or gas-powered internal combustion engine) powered by fuel 204 with a generator 206 (such as an alternator) to generate electrical power. That is, the engine 202 may generate a mechanical power output, and the generator 206 may be coupled to the engine 202 to convert at least a portion of the mechanical power output to electrical power. According to an example, a diesel internal combustion engine may provide the mechanical power output in a genset, and may be designed to run on fuel 204 such as conventional fuels, or may be adapted for use with other liquid fuels, natural gas, or other gaseous fuels. Gensets may be used for prime, continuous, or standby power, and may be implemented in various applications, including applications using single gensets and applications using a plurality of gensets, such as to provide redundancy and/or load sharing.

The engine 202 may include an internal combustion engine, e.g., a diesel engine, such as may be used for various mobile applications, and also for stationary applications such as generator sets, engine-driven compressors, engine driven pumps, and other such applications. While some applications may require a near constant load on the engine 202, the loading on an engine 202 operating in a generator set may vary relatively quickly over time, especially when the electrical load on the generator 206 varies.

As shown, the engine 202 is a stationary engine that is part of a generator set. Alternatively, the engine 202 may be part of a machine, marine vessel, off-highway truck, or the like, and be connected to an electrical generator that is part of a hybrid-electric drive system, a fluid pump that is part of a hydrostatic drive system, a transmission that is part of a machine propel system and the like. The engine 202 has an output shaft connected to a generator 206. During operation, the engine 202 may operate at a nearly constant engine speed but at a varying load depending on the electrical power or current output of the generator 206. A controller 208 may be operably associated with various engine and/or generator systems. The controller 208 in the illustrated embodiment includes operable connections to various sensors and systems of the engine 202 and generator 206, and is configured to receive information on the operating parameters thereof as well as send commands to various actuators and systems through the connections.

The operation of the engine 202 may be controlled by a controller 208 that may include a computing device, dedicated chip or circuit, or other control logic or circuitry. The controller 208 may be an example of a governor, as a generator set governor may sometimes be referred to as the speed controller for the engine 202. The controller 208 and/or governor may implement a gain 210 which corresponds to a factor in the controller 208 by which the controller implements signals at the engine 202. In an example, the gain 210 may include a parameter associated with a relationship between an error signal and the output of the controller 208. The gain 210 describes, in general, how aggressively the controller 208 responds to changes in the error signal (e.g., the difference between the desired and actual speed or another parameter of the engine 202). The gain 210 may include a parameter that is set by an operator or engineer during setup or configuration of the system 200.

The controller 208 may be a single controller or may include more than one controller disposed to control various functions and/or features of the system. For example, a master controller, used to control the overall operation and function of the generator set may be cooperatively implemented with an engine controller used to control the engine 202. In this embodiment, the term “controller” is meant to include one, two, or more controllers that may be associated with the engine 202 and that may cooperate in controlling various functions and operations of the engine 202 and generator 206.

Accordingly, the controller 208 in the illustrated embodiment is configured to receive information indicative of various operating parameters of the engine 202 and to control various operating parameters of the engine 202, such as fuel injection quantity, allowable or desired fuel substitution rates depending on the operating point of the engine 202, intake manifold air pressure, turbocharger shaft speed, cylinder pressure, and others. The engine 202 may include various components and systems, such as lubrication and electrical systems, which have been omitted from FIG. 2 for simplicity.

The controller 208 may be a standalone controller or part of a larger control scheme for controlling and monitoring the operation of the system 200 including the engine 202 and the generator 206. The controller 208 may be further integrated with and be operating within another control element of an overall environment.

The controller 208 may operate in many different operating modes such as a first, steady state mode, and in a second, transient or high load mode. As used herein, steady state refers to an operating state of the engine 202 in which changes in engine speed are generally small or sufficiently slow such that the engine 202 is capable of performing relatively minor adjustments to its engine speed or load without exceeding the abilities of its various systems to track the change, and engine load variation or change is relatively low. Transient, on the other hand, refers to an operating state in which the engine 202 is increasing its load level while maintaining engine speed within a desired range.

The gain 210 is set during a process referred to as tuning. The gain 210 may include one or more parameters for use by the controller 208, for example a proportional controller may use a single parameter, a proportional-integral (PI) controller may use two parameters, and a proportional-integral-derivative (PID) controller may use three parameters, or other control designs as one skilled in the art may derive. Tuning the gain 210 enables the controller 208 to respond to dynamic changes, such as changes in a demand from the genset. Typical tuning processes may involve operator estimations that may be inaccurate or unable to provide the desired performance and may result in sub-optimal performance of the system 200. The controller 208, with properly tuned gain 210 improves a transient response time of the engine. Accordingly, the engine 202 may provide a more stable output, thereby improving a performance of the system 200 in serving the load 214. The gain 210 may be a function of the inertia of the engine 202.

The engine 202 may need to maintain a pre-determined speed to maintain generator 206 output specifications. If the engine 202 speed is not correct the generator 206 will not maintain the required output specifications. The load 214 may include electrical components 218 as well as any physical components of a system 220.

The transient response and steady state stability of the system 200 and in particular the engine 202 may vary because of a number of factors such as engine type, engine model, engine speed, aspiration, power factor, governor design, and the presence of an idle circuit.

In an example, the present description is directed to the system 200 and specifically to a method for improving engine performance during transient events in a way that allows the engine 202 to increase its load output quickly. Transient event, as used herein, may refer to a change of engine operating parameters such as engine speed and/or load, from one operating state to another. Specifically in the context of electrical power gensets, a transient event contemplated is engine operation in which a near constant (+/−10 RPM) engine speed is maintained, or recovered in a case of a speed droop, while an engine load changes, for example, is increased quickly during a short time period to meet a sudden electrical power demand increase. The systems and methods described herein provide a maximum reasonable amount of power during a time period between an initial operating state of the engine 202, a final operating state of the engine 202, and during the transient event that lies therebetween.

In some examples, the systems and techniques described herein may provide a method for determining inertia of the system 200 for determining the gain 210. This may be performed as an initial setup or configuration of the system and may be performed using a computing device coupleable to and/or in communication with the controller 208 of the system 200. A first gain value, such as a known value associated with the engine 202 and/or the engine 202 and generator 206 may be provided to the controller 208. The first gain is associated with a first inertia of the system 200 and is a known value, such as may be determined at a factory setting, during development, or in a controlled environment. The first gain is associated with a reference system such as the engine 202 and a load 214 that the controller 208 and gain 210 is developed for. A second gain may be associated with the controller 208 and the gain 210 and the load 214 includes a field driven load. The response of the system 200 with no external load and the field system with no external load can be used to find the ratio of the field system inertia with respect to the baseline system inertia.

The load 214 and/or energy storage 212 may be removed from the generator 206 or the engine 202. The load 214 may be removed from the generator 206 by opening a breaker 216 to disconnect an electrical components 218 and/or otherwise to remove the load on a system 220.

After the load 214 is removed, the engine 202 and generator 206 may be perturbed, such as by providing a step input to the engine speed to cause a step input in the fuel 204 for the engine 202 to increase the engine speed over a temporary period of time. The generator 206 may in some instances be other equipment such as pumps or other driven systems. The rate of change of the engine speed in response to the perturbation may be recorded during a transient period, including an increase and a decrease in engine speed in response to the step input in fuel 204 and/or the engine speed.

In examples, the energy from the engine 202 may not be exactly known due to losses within the engine 202 and/or system 200. The energy output of the engine 202 being repeatable, even if unknown, enables determination of the inertia. The ratio of the rate of change in response of the engine 202 and generator 206 in the field system with an unknown driven inertia to the response of the engine 202 and generator 206 as a reference system with a known driven inertia may be used to determine the inertia of the system 200. By comparing the response of the field system and the reference system, the unknown inertia may be determined based on the ratio of the acceleration response in each circumstance.

In response to the perturbations and the resultant change in the engine speed, the inertia of the system 200 may be estimated and/or determined. In examples, the inertia may not be determined, but rather the relative inertia of the first configuration (e.g., factory setting) and the inertia in the field may be compared to determine the gain 210. As the engine speed is impacted by the driven inertia of the system 200, adjustment of the gain 210 with a change in inertia is conventional, however the estimation or determination of inertia of the system 200 is difficult to determine. The gain 210 and the inertia are related by equation (3) described above.

As illustrated by the equation (3), the total inertia of the system 200 may be estimated by comparing the first rate of change of the engine speed with the second rate of change of the engine speed. As the first inertia associated with the first portion of the system 200 may be a known quantity, the relation between the original and new inertia may be determined based on the acceleration response of the engine to the same torque. Though described herein with reference to fuel perturbations, other perturbations could be used induce the engine speed change. For example, a step function in the fuel 204 may be used. In an embodiment, a sine wave may be introduced. The perturbation could be directly on fuel or could be induced by perturbations of desired engine speed into the controller 208.

Examples described herein relate to the use of step function inputs to the engine control. Those having skill in the art will understand that additional inputs could be used such as ramps, sine waves, white noise, and other such inputs. The other input, such as the sine wave, may be used to determine additional factors and information beyond just the inertia.

The expected response of the system 200 to the perturbation depends on the driven system such as the generator 206 and load 214. In an example, a genset may provide for easily monitoring the rate of change of the engine speed when the breaker 216 is open as described above. In such a manner, the driven system is reduced to just the generator 206. Other systems connected to the engine 202 such as water pumps, hydraulic pumps, gear boxes, and other such driven components are connected to the engine 202 but not loaded.

In examples, the gains for the engine 202 may initially be determined at a lab, factory, or other controlled environment to provide a known inertia. The acceleration rates of the engine 202 are determined with the known inertia and stored. In examples, the baseline acceleration response rates may be determined without any driven inertia or may be driven with a known driven inertia. In the field, the system 200 may be coupled to the engine 202 and the system 200 may include components driven by the engine having an unknown inertia. To determine the unknown inertia, the response of the field system connected to the engine 202 may be measured, such as when the breaker 216 is open at the load 214 and the acceleration response is recorded with the unknown driven inertia connected. The ratio of the acceleration response rates may then be used to determine the unknown inertia and/or to determine gains for the engine 202 and the system 200 (e.g., in some examples the inertia may not be calculated, but the controller gains may be determined based on the acceleration response rate).

During setup of the system 200 and/or during service to the system 200 in the field, the service technician and/or customer may connect or use a device to record the rate of change in engine speed (acceleration) with the field components such as the generator 206 coupled. The response of the engine 202 is scalable in response to the gain 210. The system 200 may be implemented in a tool to initiate the test and/or methods as described herein and the methods and calculations described herein may be performed in a computing device associated with the system 200 such as in an ECM.

As previously mentioned, the total inertia of the engine 202 and a designed system may be known from factory settings but a field system may be unknown, so setting the gain 210 is difficult to maintain the stability in the system 200 in response to the different components and conditions for the field system.

In some examples, the process to determine the inertia of the system 200 may be performed by using an algorithm or machine learning technique that receives inputs of the perturbations as well as the responses by the engine 202 over a period of time following the perturbation. In practice, the determination of the inertia may be performed using one or more techniques such as a machine learning model, neural network, and the like, which correlate the response rates of the engine speed in response to the perturbations when loaded and unloaded to determine the inertia of the system 200 and therefore output an optimal gain value for stability of the system 200.

In some examples, the load 214 may include more complex systems such as various steps or stages for multiple pumps or driven systems. Accordingly, the system 220 may include multiple separate driven systems powered by the engine 202.

In examples, the processes described herein provide for a technician, controller, or other system to update the gains when the engine 202 is placed in the field with different driven inertias than when initially configured at a factory. Accordingly, the processes provide for a technician to use a software tool to perform acceleration response tests to inputs without requiring knowledge of the physics of the system 200 and without a large amount of special instrumentation, as the engine response rate is the value recorded by the tool.

Though shown and described at places within this description as a linear output or response to the step function perturbation, the response may not be linear in some examples. In such examples, the speed for the engine 202 may be selected at a range where the change in response with speed is generally linear over a limited range and/or at a typical operating speed.

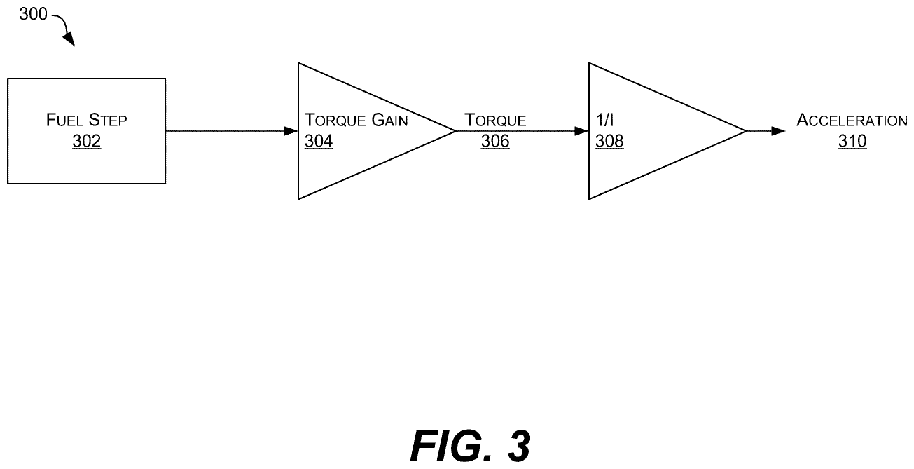

Turning now to FIG. 3, which illustrates a representation 300 of inputs and data used for determining factors such as torque and acceleration to determine the inertia of a system connected to an engine for determining a controller gain setting, according to at least one example. The representation 300 illustrates an example process for determining the inertia of the system in response to the perturbation described above with respect to FIG. 2. Accordingly, the fuel step 302 is a result of a change in the set engine speed of the engine 202 of FIG. 2. The change in engine speed may also include other input changes such as an engine speed set point change or other such input. The engine speed and/or fuel step 302 or other such input may be provided as a step function that provides an increase in fuel and/or set point for a first period of time before returning to the previous set point or fuel delivery rate.

In response to the fuel step 302, the representation 300 shows that a gain value 304 of fuel to torque (separate from the controller gain discussed herein) is shown to illustrate that the engine 202 produces torque 306 in response to the fuel step 302 as a function of the gain value 304. The torque 306 is the torque of the engine 202 as well as the torque of the load 214 (e.g., the usable torque). The usable torque of the engine may be subtracted out from the system by having the engine 202 operate at steady state and/or by removing the load from the engine 202, however in the field and without instrumentation such a determination may be difficult to achieve and therefore the methods and system provided herein enable a test done with no load in the field to enable the gain setting as described herein. The relationship between torque 306 (τ), acceleration (α), and inertia is shown in equation (4).

$$I = \frac{τ}{α} \qquad Equation ( 4 )$$

In one embodiment, the gain 210 may be determined by computing the inertia using equation (4), wherein I indicates the system inertia, t indicates the torque estimated value, and a indicates the acceleration estimated value. However, the above description is only one of the exemplary embodiments of the present disclosure, but not limited thereto. As shown in equation (4), the torque 306 of the driven system is equal to the acceleration 310 (radial acceleration) multiplied by the inertia 308. The inertia 308 is therefore found by dividing the torque 306 by the acceleration 310. Accordingly, the fuel step 302 or perturbation multiplied by the gain value 304 and divided by the acceleration 310 results in the inertia 308 of the driven system, as shown in equation (5).

$$I = \frac{fuel * K}{α} \qquad Equation ( 5 )$$

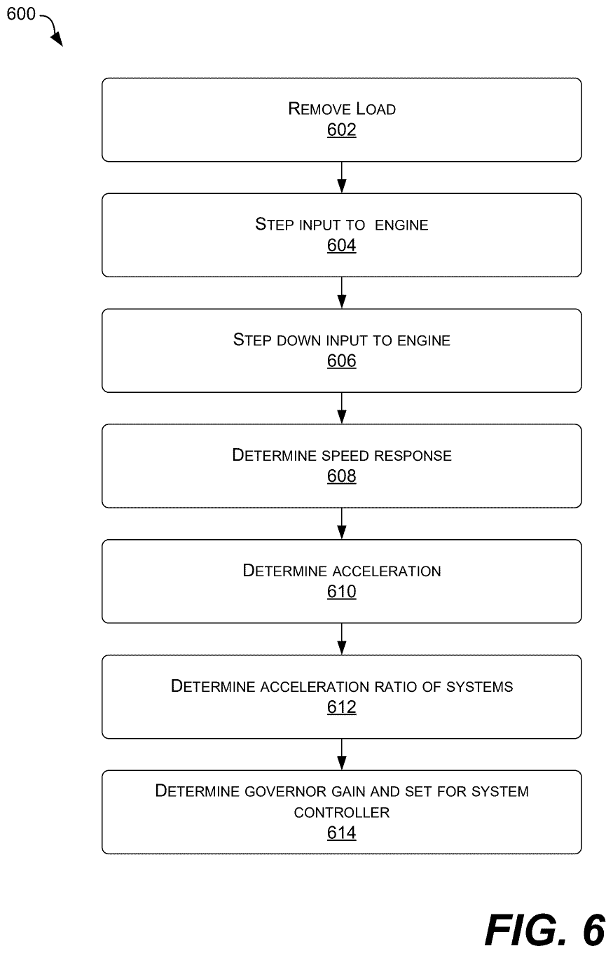

After estimating the inertia 308 (or the acceleration 310), the gain 210 of the controller 208 may be adjusted. The determinations illustrated by representation 300 may be performed by a computing device, such as the computing device of FIG. 6 that receives data such as engine speed data as well as data relating to the fuel step 302 or other step input. Accordingly, the computing device may be used to determine the estimated inertia and therefore determine a gain 210 for the controller 208 to improve stability and performance of the system 200.

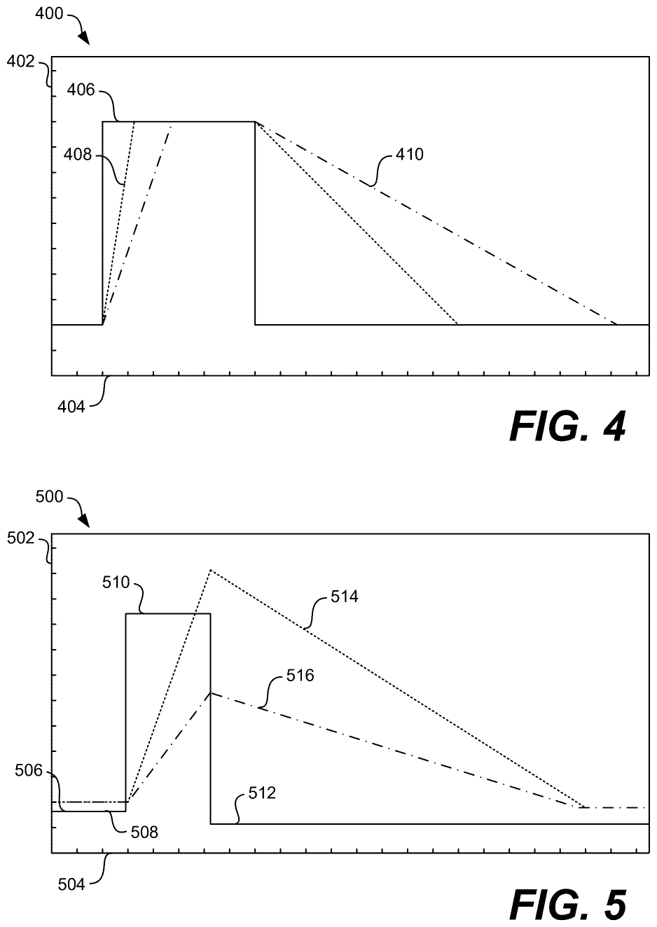

FIG. 4 illustrates a diagram 400 of a desired speed control and response of a system based on a first and a second inertia for determining a controller gain setting, according to at least one example. The diagram 400 is shown with a dependent axis 402 illustrating a magnitude of the input and/or response by the system and an independent axis 404 illustrating time. The diagram 400 may, in an embodiment, be illustrative of a step input 406 for engine speed control (e.g., a desired engine speed) and the diagram 400 shows the engine speed response to the step input in the desired engine speed. The step input 406 illustrates a temporary or transitory increase in the speed control setting of the engine 202 of system 200 in an example. The step change in the desired speed (e.g., speed setpoint) matches the engine speed and then the fuel input is dropped to maintain the speed at the desired speed. When the desired speed (e.g., setpoint) is dropped, the fuel is set to zero until the speed reaches the desired speed and then the fuel is increased to maintain the speed at the desired speed. The system producing the data of diagram 400 may include the system 200 or a similar system with one or more driven systems coupled to an engine.

The diagram shows the step input 406 corresponding with a temporary increase in the engine speed set point for the engine 202. The step input 406 may be provided and/or caused to increase through the controller 208. The step input 406 may be instructed from a device in communication with the controller 208 such as a handheld computing device or other computing device including an input for setting the gain 210.

The step input 406 increases from a first level to a second level indicating an increase from a first speed to a second speed. After a predetermined period of time, the step input 406 decreases from the second speed to the first speed. The step input 406 may be over a predetermined time interval or, in some examples, may continue for a duration until the engine speed reaches within a threshold amount of the second speed set point. The step input 406 then decreases back to the first speed set point or to a third speed set point that is lower than the second speed set point.

The diagram 400 includes a first engine speed 408 and a second engine speed 410. The first engine speed 408 may correspond to the system 200 in a factory or development configuration. Accordingly, the first engine speed 408 and the second engine speed 410 may correspond to the system 200 in response to an identical step input 406. The second engine speed 410 may correspond to the system 200 installed in a field installation with components such as a generator or other components connected. With the components connected to the engine 202 such that the engine 202 is driving the entire system (with no load). Accordingly, a first slope of the response to the step input 406 for the second engine speed 410 is lower than a second slope of the first engine speed 408. The first engine speed 408 is able to reach the second speed set point of the step input 406 faster than the second engine speed 410 due to the increased inertia driven by the engine as illustrated by the second engine speed 410.

The slope of the first engine speed 408 and the slope of the second engine speed 410 corresponds to the acceleration of the engine 202 in response to the step input 406. The response rate (acceleration) of the engine 202 is a function of the inertia driven by the engine 202. Accordingly, when the inertia increases, the engine speed responds slower to the changes in the step input 406. The relative slope of the first engine speed 408 and the second engine speed 410 may be used to estimate the inertia of the driven system, as described above with respect to FIGS. 2 and 3.

FIG. 5 illustrates a diagram 500 of a step fuel input 506 perturbation to an engine and a response of a system based on a first inertia and a second inertia for determining a controller gain setting, according to at least one example. The diagram 500 is shown with a dependent axis 502 illustrating a magnitude of the input and/or response by the system and an independent axis 504 illustrating time. The diagram 500 may, in an embodiment, be illustrative of a step fuel input engine control as well as engine speed response to the step fuel input 506.

The step fuel input 506 illustrates a temporary or transitory increase in the fuel provided to the engine 202 of the system 200 in an example. The system producing the data of diagram 500 may include the system 200 or a similar system with one or more driven systems coupled to an engine. The fuel provided may directly correlate to an increase in engine torque, which will result in acceleration or deceleration of the engine to control the engine speed. The step fuel input 506 steps from a first level 508 to a second level 510 and to a third level 512. The step fuel input 506 may increase from a first level 508 to the second level 510 before decreasing to the third level 512. The change from the step fuel input 506 from the first level 508 to the second level 510 will cause the engine speed to increase. The engine will continue to increase speed until the friction torque equals the engine torque, accordingly, to prevent damage the step fuel input 506 is stepped down before such speeds are achieved. The third level 512 may be the same, similar, or different from the first level, but provides for a decrease from the temporary fuel increase to the engine 202. The third level 512 may be, for example, with zero fuel and would cause the engine to decelerate until zero speed is reached. The step fuel input 506 that causes the engine to produce torque and therefore cause acceleration can be used, as described herein, to determine the difference in inertia between two systems (such as a factory-configured system versus a field-deployed system).

The diagram shows the step fuel input 506 corresponding with a temporary increase in the engine fuel causing increased engine torque and therefore acceleration for the engine 202. The step fuel input 506 may be provided and/or caused to increase through the controller 208. The step fuel input 506 may be instructed from a device in communication with the controller 208 such as a handheld computing device or other computing device including an input for setting the gain 210.

The diagram 500 includes a first engine speed 514 and a second engine speed 516. The first engine speed 514 may correspond to a first system such as configured in a factory setting and the second engine speed 516 may correspond to a second system such as a field-deployed system in response to the step fuel input 506 executed without the load 214. Accordingly, a first slope of the response to the step fuel input 506 for the second engine speed 516 is lower than a second slope of the first engine speed 514, though the opposite may be true in some examples. The first engine speed 514 is able to reach the second speed set point of the step fuel input 506 faster than the second engine speed 516 due to the differences in inertia between the systems.

The slope of the first engine speed 514 and the slope of the second engine speed 516 corresponds to the acceleration of the engine 202 in response to the step fuel input 506. The response rate (acceleration) of the engine 202 is a function of the inertia driven by the engine 202. Accordingly, when the inertia increases, the engine speed responds slower to the changes in the step fuel input 506. The relative slope of the first engine speed 514 and the second engine speed 516 may be used to estimate the inertia of the driven system, as described above with respect to FIGS. 1-3.

Though shown and described with respect to FIGS. 4 and 5 as a step input function for the engine speed and/or fuel input to the engine, in some examples the input may have a different profile. Those having skill in the art will understand that additional inputs could be used such as ramps, sine waves, white noise, and other such inputs. Additionally, those having skill in the art will understand that additional methods may be used to perturb the system to a repeatable load disturbance other than changing a fuel input or engine speed setting.

FIG. 6 illustrates a method for determining a controller gain setting for an engine and driven system, according to at least one example. The method 600 and other processes described herein are illustrated as example flow graphs, each operation of which may represent a sequence of operations that can be implemented in hardware, software, or a combination thereof. In the context of software, the operations represent computer-executable instructions stored on one or more tangible computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. The method 600 can be implemented or controlled by a controller, such as the controller 208 of FIG. 2. The controller 208 may be comprised of hardware, software, or various combinations thereof, described by way of example in FIG. 6.

At step 602, the method 600 includes removing a load from the system, but the driven device is still connected to the engine. In an example, this may include opening a series of electrical breakers to remove the load on the system while keeping physical components coupled together as installed.

The method 600 may, in some examples, include a step prior to step 602 that includes determining acceleration response of the system to the fuel input in a development or factory setting and then when the system is deployed in an environment, the method may commence at step 602. The method 600 relies upon determination of an optimal gain or a gain setting that achieves a certain threshold of performance during development of the system and then finding the response to the gains with the development inertia, in the field and with the field inertia the test is repeated to obtain the response and the difference in the response can be used to make adjustments to the gain. Accordingly, though various methods may be used to obtain a response and/or gain setting from the development step, the field test is compared against the development test to determine the field gain settings.

The load is removed from the system including the engine 202 to isolate the inertia of the engine and the driven components without a load on the system. In an embodiment of a genset, the load may be removed by opening a breaker to disconnect an electrical load on the system. In some examples the engine may be coupled with a pump, grinder, or other physical load that is not performing any operations (e.g., pump not pumping any fluid etc.). In some examples, a first operation includes determining the controller settings (e.g., gain) using a controlled or a factory setting, such as with a system having a known inertia (e.g., run against a dyno). The results of such a test may be stored in the controller and subsequently be used to determine the updated controller gain when the system is installed in the field.

At step 604, the method 600 includes providing a step input to the engine. The method 600 is performed in the factory setting or configuration setting with a first driven system (and resulting first inertia) and subsequently in the field installation with a second driven system (and resulting second inertia). In each case, the driven systems do not perform any useful work during the test of the method 600 and setting of the controller gain. The engine may be perturbed, such as by providing a step input to the fuel and/or engine speed for the engine to increase the engine speed over a temporary period of time. The rate of change of the engine speed in response to the perturbation may be recorded during a transient period, including an increase and a decrease in engine speed in response to the step input in fuel and/or the engine speed. The step input may be within a predetermined range, such that the engine speed remains within a predefined operating range of speeds. In this manner, the engine speed may remain below a saturation limit and well within normal operating conditions for the system such that the settings determined based on an estimated inertia are likely to be accurate and optimal within the operating range of the engine during normal operation.

At step 606, the method 600 includes stepping down the input to the engine. After the step input is provided to the engine, the engine speed increases. When the engine speed reaches the target engine speed, within a threshold of the target engine speed, or reaches a plateau, the engine speed may be determined to have reach the set point indicated by the step input. In some examples, after a predetermined period of time, the step input is stepped down to the original operating condition (e.g., lower operating speed). In some examples, the step input may be stepped down after the engine speed reaches a steady state condition for a predetermined period of time.

At step 608, the method 600 includes determining a speed response of the engine. The speed response of the engine is recorded in response to the step input. The speed response may include a first response for acceleration of the engine and a second response for deceleration of the engine. The acceleration response may be in response to the increase of the step input and the deceleration response may be in response to the decrease of the step input. In some examples, the controller and/or other computing device used to estimate the inertia and/or perform the method 600 may identify the first response and the second response based on the engine speed changing within a predetermined time period of a change in the engine speed or fuel input. In some examples, the computing device may identify the first response and the second response based on the engine speed changing amplitude by at least a threshold amount. In this manner, the computing device may select a subset of the engine speed data and may automatically identify the speed responses and rate of responses to identify differences in the rate of responses and thereby identify the inertia of the system.

At step 610, the method 600 may include determining an acceleration for the system. The acceleration of the engine may be determined from a slope or derivative of the speed of the engine. The acceleration may be determined from the speed response of the system.

At step 612, the method 600 includes determining the acceleration ratio between the first system and the second system, the factory-configured system and the deployed system.

At step 614, the method 600 includes determining a governor gain and setting the gain for the system controller. The ratio of the gain is described above with respect to Equation 3 and equates to the base gain value multiplied by the base acceleration divided by the new acceleration (e.g., of the field test). The new gain is input into the control of the system. In some examples the new gain may be input in several different ways based on the design of the control interface of the system, for example by inputting the actual gain or by inputting a multiplier of the base gain or some other manner that will be apparent to those skilled in the art.

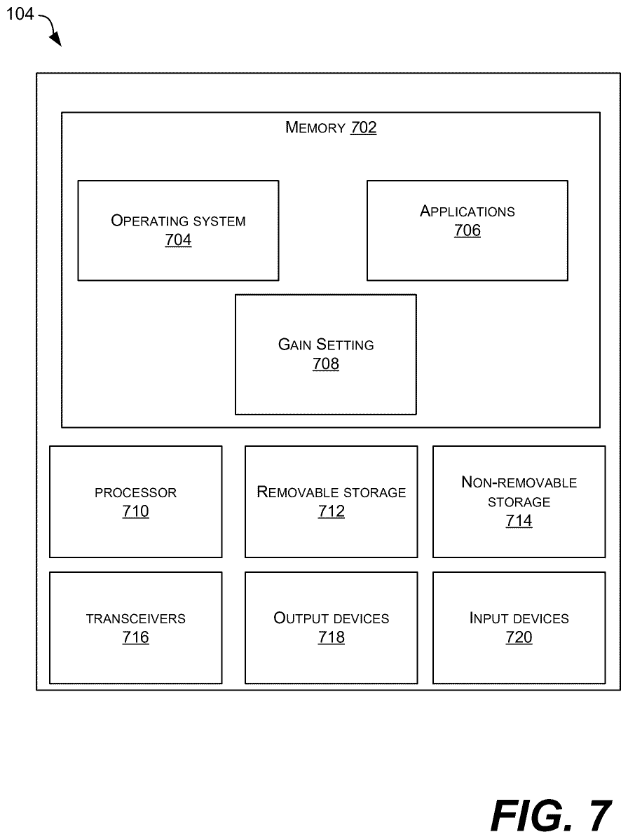

FIG. 7 depicts an example of a component level view of the controller 104 for use with the systems and methods described herein, in accordance with various examples of the presently disclosed subject matter. The controller 104 could be any device capable of providing the functionality associated with the systems and methods described herein. The controller 104 can comprise several components to execute the above-mentioned functions. The controller 104 may be comprised of hardware, software, or various combinations thereof. As discussed below, the controller 104 can comprise memory 702 including an operating system (OS) 704 and one or more applications 706. The applications 706 may include applications that provide for control of fuel system components and/or speed control for the engine of the system 100, as well as implement one or more steps of the method 600 described above. In some examples, one or more steps of the method 600 may be performed by a separate computing devices including at least one or more processors and one or more non-transitory computer readable media having instructions stored thereon that, when executed by the one or more processors, may be used to implement the methods and techniques described herein.

The controller 104 can also comprise one or more processors 710 and one or more of removable storage 712, non-removable storage 714, transceiver(s) 716, output device(s) 718, and input device(s) 720. In various implementations, the memory 702 can be volatile (such as random-access memory (RAM)), non-volatile (such as read only memory (ROM), flash memory, etc.), or some combination of the two.

The memory 702 can also include the OS 704. The OS 704 varies depending on the manufacturer of the controller 104. The OS 704 contains the modules and software that support basic functions of the controller 104, such as scheduling tasks, executing applications, and controlling peripherals and valves. The OS 704 can also enable the controller 104 to send and retrieve other data and perform other functions. The memory 702 further stores the gain setting 708 for use by the controller 104, for example as a gain setting in a proportional-integral, proportional-integral-derivative, or other control system.

In some implementations, the processor(s) 710 can be one or more central processing units (CPUs), graphics processing units (GPUS), microcontroller units (MCUs), CPUs, GPUs, MCUs, and/or any other combinations and numbers of processing units. The controller 104 may also include additional data storage devices (removable and/or non-removable) such as, for example, magnetic disks, optical disks, or tape. Such additional storage is illustrated in FIG. 7 by removable storage 712 and non-removable storage 714.

Non-transitory computer-readable media may include volatile and nonvolatile, removable and non-removable tangible, physical media implemented in technology for storage of information, such as computer readable instructions, data structures, program modules, or other data. The memory 702, removable storage 712, and non-removable storage 714 are all examples of non-transitory computer-readable media. Non-transitory computer-readable media include, but are not limited to, RAM, ROM, electronically erasable programmable ROM (EEPROM), flash memory or other memory technology, compact disc ROM (CD-ROM), digital versatile discs (DVD) or other optical storage, magnetic cassettes, magnetic tape, magnetic disk storage or other magnetic storage devices, or any other tangible, physical medium which can be used to store the desired information, which can be accessed by the controller 104. Any such non-transitory computer-readable media may be part of the controller 104 or may be a separate database, databank, remote server, or cloud-based server.

In some implementations, the transceiver(s) 716 include any transceivers known in the art. In some examples, the transceiver(s) 716 can include wireless modem(s) to facilitate wireless connectivity with other components (e.g., between the controller 104 and one or more pumps or valves), the Internet, and/or an intranet. Specifically, the transceiver(s) 716 can include one or more transceivers that can enable the controller 208 to send and receive data. Thus, the transceiver(s) 716 can include multiple single-channel transceivers or a multi-frequency, multi-channel transceiver to enable the controller 104 to send and receive video calls, audio calls, messaging, etc. The transceiver(s) 716 can enable the controller 104 to connect to multiple networks including, but not limited to 2G, 3G, 4G, 5G, and Wi-Fi networks. The transceiver(s) 716 can also include one or more transceivers to enable the controller 104 to connect to future (e.g., 5G) networks, Internet-of-Things (IoT), machine-to machine (M2M), and other current and future networks. The transceivers 716 may also include wired connections to facilitate wired communications with one or more components.

The transceiver(s) 716 may also include one or more radio transceivers that perform the function of transmitting and receiving radio frequency communications via an antenna (e.g., Wi-Fi or Bluetooth®). In other examples, the transceiver(s) 716 may include wired communication components, such as a wired modem or Ethernet port, for communicating via one or more wired networks. The transceiver(s) 716 can enable the controller 104 to facilitate audio and video calls, download files, access web applications, and provide other communications associated with the systems and methods, described above.

In some implementations, the output device(s) 718 include any output devices known in the art, such as a display (e.g., a liquid crystal or thin-film transistor (TFT) display), a touchscreen, speakers, a vibrating mechanism, or a tactile feedback mechanism. Thus, the output device(s) can include a screen or display. The output device(s) 718 can also include speakers, or similar devices, to play sounds or ringtones when an audio call or video call is received. Output device(s) 718 can also include devices to output control signals to operate the engine and/or system as may be implemented. The signals may include injector waveforms, current signals, pulse-width modulation signals, voltage signals, frequency signals, on/off commands, communication signals, and other such signals as will be understood by those with skill in the art. Output device(s) 718 can also include ports for one or more additional peripheral devices.

In various implementations, input device(s) 720 include any input devices known in the art. For example, the input device(s) 720 may include a camera, a microphone, or a keyboard/keypad. The input device(s) 720 can include a touch-sensitive display or a keyboard to enable users to enter data and make requests and receive responses. The inputs received through the input device(s) 720 may also include devices to receive pulse-width modulation inputs, voltage, current, switch inputs, communication signals, and other such inputs as will be understood by those with skill in the art. A touch-sensitive display or keyboard/keypad may be a standard push button alphanumeric multi-key keyboard (such as a conventional QWERTY keyboard), virtual controls on a touchscreen, or one or more other types of keys or buttons, and may also include a joystick, wheel, and/or designated navigation buttons, or the like. A touch sensitive display can act as both an input device 720 and an output device 718.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features, it is to be understood that the subject matter defined in the appended claims is not necessarily limited to the specific features described. Rather, the specific features are disclosed as illustrative forms of implementing the claims.

### INDUSTRIAL APPLICABILITY

The present disclosure provides systems and methods for engine controller setup and specifically for system inertia estimation and gain setting for a controller of the system. The gain of the controller may be accurately set in this manner rather than through a typical system where the gain must be guessed and evaluated. In this way, engine speed recovery to a steady state is improved by the control system. Accordingly, the control system improves a transient response time of the engine and the engine may provide a more stable output, thereby improving a performance of the primary load.

The systems and methods allow technicians in the field to optimize gains for controllers without requiring knowledge of the system. In many instances, technicians adjust the gains until the system appears to be functioning better without understanding the system, resulting in sub optimal performance of the system. Additionally, the gain may be initially accurately set through a system implemented by a computing device to more efficiently accomplish setup and tuning of the system and save down-time or setup time for the system, resulting in time efficiencies and gains for the system as a whole.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A method comprising:
determining a first gain for a controller of a first system including an internal combustion engine, the first gain associated with a first inertia of the first system;
introducing a first perturbation to change an engine speed of the internal combustion engine, the first perturbation introduced while the internal combustion engine is decoupled from a second system;
determining a first rate of change of the first system in response to the first perturbation;
installing the internal combustion engine in a field installation by coupling at least the internal combustion engine of the first system to the second system;
introducing, after the coupling, a second perturbation to change the engine speed, the second perturbation equal to the first perturbation;
determining a second rate of change of the second system in response to the second perturbation;
determining a second gain for the controller based at least in part on a ratio of the first rate of change to the second rate of change, wherein determining the second gain comprises scaling the first gain by the ratio of the first rate of change to the second rate of change such that a system gain of the second system matches a reference system gain of the first system; and
controlling operation of the second system based on the second gain.

2. The method of claim 1, wherein the second system comprises a generator including an electrical generator coupled to a system for consuming electrical power.

3. The method of claim 2, wherein coupling at least the internal combustion engine to the second system comprises opening or disconnecting a circuit breaker at the generator.

4. The method of claim 1, wherein the first perturbation comprises a step function input for fuel input to the internal combustion engine.

5. The method of claim 1, wherein the first perturbation comprises a step function input for a speed control of the internal combustion engine.

6. The method of claim 1, wherein the first inertia comprises a known inertia associated with the first system.

7. The method of claim 1, further comprising:
storing the first rate of change of the first system in a memory for an engine controller of the second system, and wherein determining the second gain comprises accessing the first rate of change from the memory of the second system.

8. A system comprising:
one or more processors; and
a non-transitory computer readable medium having instructions stored thereon that, when executed by the one or more processors, causes the one or more processors to perform operations comprising:
determining a first gain for a controller of a first system including an internal combustion engine, the first gain associated with a first inertia of the first system;
introducing a first perturbation to change an engine speed of the internal combustion engine, the first perturbation introduced while the internal combustion engine is decoupled from a second system;
determining a first rate of change of the first system in response to the first perturbation;
installing the internal combustion engine in a field installation by coupling at least the internal combustion engine of the first system to the second system;
introducing, after the coupling, a second perturbation to change the engine speed, the second perturbation equal to the first perturbation;
determining a second rate of change of the second system in response to the second perturbation;
determining a second gain for the controller based at least in part on a ratio of the first rate of change to the second rate of change, wherein determining the second gain comprises scaling the first gain by the ratio of the first rate f change to the second rate of change such that a system gain of the second system matches a reference system gain of the first system; and
controlling operation of the second system based on the second gain.

9. The system of claim 8, wherein the second system comprises a generator including an electrical generator coupled to a system for consuming electrical power.

10. The system of claim 9, wherein coupling at least the internal combustion engine with the second system comprises opening or disconnecting a circuit breaker at the generator.

11. The system of claim 8, wherein the first perturbation comprises a step function input for fuel input to the internal combustion engine.

12. The system of claim 8, wherein the first perturbation comprises a step function input for a speed control of the internal combustion engine.

13. The system of claim 8, wherein the second system includes a pump system or gear train associated with a driven system.

14. The system of claim 8, wherein the controller comprises a governor for the internal combustion engine.

15. A non-transitory computer-readable medium having instructions stored thereon that, when executed by one or more processors, cause the one or more processors to perform operations comprising:
determining a first gain for a controller of a first system including an internal combustion engine, the first gain associated with a first inertia of the first system;
introducing a first perturbation to change an engine speed of the internal combustion engine, the first perturbation introduced while the internal combustion engine is decoupled from a second system;
determining a first rate of change of the first system in response to the first perturbation;
installing the internal combustion engine in a field installation by coupling at least the internal combustion engine of the first system to the second system;
introducing, after the coupling, a second perturbation to change the engine speed, the second perturbation equal to the first perturbation;
determining a second rate of change of the second system in response to the second perturbation;
determining a second gain for the controller based at least in part on a ratio of the first rate of change to the second rate of change, wherein determining the second gain comprises scaling the first gain by the ratio of the first rate of change to the second rate of change such that a system gain of the second system matches a reference system gain of the first system; and
controlling operation of the second system based on the second gain.

16. The non-transitory computer-readable medium of claim 15, wherein the second system comprises a generator including an electrical generator coupled to a system for consuming electrical power.

17. The non-transitory computer-readable medium of claim 16, wherein coupling at least the internal combustion engine with the second system comprises opening or disconnecting a circuit breaker at the generator from a power consumption system.

18. The non-transitory computer-readable medium of claim 15, wherein the first perturbation comprises a step function input for fuel input to the internal combustion engine.

19. The non-transitory computer-readable medium of claim 15, wherein the first perturbation comprises a step function input for a speed control of the internal combustion engine.

20. The non-transitory computer-readable medium of claim 15, wherein the controller comprises a governor for the internal combustion engine.
